(19) United States
(12) Patent Application Publication
(10) Pub. No.: US 2017/0122020 A1
(43) Pub. Date: May 4, 2017

(54) APPLIANCE LID HINGE ASSEMBLY WITH SNUBBER

(71) Applicant: Mansfield Engineered Components, Inc., Mansfield, OH (US)

(72) Inventor: James Collene, Bucyrus, OH (US)

(73) Assignee: Mansfield Engineered Components, Inc., Mansfield, OH (US)

(21) Appl. No.: 15/342,830

(22) Filed: Nov. 3, 2016

Related U.S. Application Data
(60) Provisional application No. 62/250,244, filed on Nov. 3, 2015.

(51) Int. Cl. E05F 3/20; D06F 58/20; D06F 37/18; D06F 37/24; E05F 5/10; E05F 3/18

(52) U.S. Cl. CPC E05F 3/20; E05F 5/10; E05F 3/18; D06F 37/18; D06F 37/24; D06F 58/20; E05Y 2900/30

(57) ABSTRACT

A hinge assembly for pivotally connecting an associated appliance lid to an associated appliance body includes a base adapted to be connected to the associated appliance body. A cam is rotatably supported on the base and is adapted to be engaged by the associated appliance lid and is rotatable about a lid pivot axis. A snubber/damper is operatively connected to the base. The cam exerts a snubber activation force on the snubber when said cam rotates about the lid pivot axis in a first direction corresponding to movement of the associated appliance lid from an opened position toward a closed position such that the snubber damps movement of the cam when the cam rotates in the first direction.

### CROSS-REFERENCE TO RELATED APPLICATION

This application claims priority from U.S. provisional application Ser. No. 62/250,244 filed Nov. 3, 2015, and the entire disclosure of said provisional application is hereby expressly incorporated by reference into the present specification.

### BACKGROUND

Top-loading appliances such as clothes washing and drying machines include a lid that pivots about a horizontal pivot axis between an opened and a closed position. When pivoted upward to the opened position, the lid is moved away from and provides access to a chamber for washing or drying clothes or for another purpose that varies depending upon the function of the appliance. When pivoted downward to the closed position, the lid is moved into abutment with the appliance body and covers an open mouth or entrance of the chamber in order for the appliance to function properly, quietly, safely, and efficiently. Because movement of the lid from its opened position to its closed position is associated with pivoting movement of the lid downward as aided by gravity, it has been deemed desirable to prevent harsh closing or “slamming” of the lid as it closes. As such, a need has been identified for a lid hinge assembly for a top-loading appliance that dampens or cushions movement of the lid as it moves to its closed position but that also fits within a small envelope, is self-contained so as to be easily installed or replaced, is cost-effective, and that is sufficiently durable to withstand heavy use over many years in a damp environment of variable temperature.

Another drawback associated with known damping systems for top-loading appliances is that the damping mechanism prevents the lid from completely and tightly closing and abutting the appliance body when the lid is moved to its closed position, which has undesired effects on aesthetics, safety, noise, and overall operation of the appliance. For example, if the appliance control system senses that the lid is opened, the control system will sometimes interrupt the clothes washing, drying, or other operation being performed as a safety feature. As such, a need has been identified for a damping system for the lid of a top-loading appliance that provides effective damping without inhibiting complete closing of the lid.

### SUMMARY

In accordance with one aspect of the present development, a hinge assembly for pivotally connecting an associated appliance lid to an associated appliance body includes a base adapted to be connected to the associated appliance body. A cam is rotatably supported on the base and is adapted to be engaged by the associated appliance lid and is rotatable about a lid pivot axis. A snubber/damper is operatively connected to the base. The cam exerts a snubber activation force on the snubber when said cam rotates about the lid pivot axis in a first direction corresponding to movement of the associated appliance lid from an opened position toward a closed position such that the snubber damps movement of the cam when the cam rotates in the first direction.

### BRIEF DESCRIPTION OF DRAWINGS

FIG. 1 is an isometric view of a top-loading appliance such as a clothes washing machine including a lid that is pivotally connected to a body by at least one lid hinge assembly provided in accordance with the present development;

FIG. 2 is a partial view of the lid of the appliance of FIG. 1 by itself and shows that the lid includes first and second hinge arms connected respectively to opposite first and second lateral sides of the lid;

FIG. 3A is a front isometric view of a hinge assembly with a snubber in accordance with an embodiment of the present development;

FIG. 3B is a top plan view of the hinge assembly of FIG. 3A;

FIG. 3C is a rear isometric view of the hinge assembly of FIG. 3A;

FIG. 3D is a right side view of the hinge assembly of FIG. 3A;

FIG. 3E is a front view of the hinge assembly of FIG. 3A;

FIG. 3F is a section view of the hinge assembly of FIG. 3A as taken at F-F in FIG. 3E;

FIGS. 4A, 4B, and 4C are section views corresponding to FIG. 3F and respectively show the hinge assembly in first, intermediate, and second positions corresponding respectively to an opened position of the appliance lid (FIG. 4A), a partially opened (or partially closed) position of the appliance lid (FIG. 4B), and a closed or fully closed position of the appliance lid (FIG. 4C);

FIGS. 5A and 5B show one example of a suitable snubber used in the hinge assembly of FIG. 3A, which is a self-contained damper cylinder that uses air, oil or another damping fluid and/or that uses a mechanical spring for damping;

FIG. 6 is a section view similar to FIG. 4C of a hinge assembly provided in accordance with an alternative embodiment wherein the snubber of FIGS. 5A and 5B is replaced by an alternative snubber including a snubber rod engaged with a spring to provide a rod-snubber damped hinge assembly.

### DETAILED DESCRIPTION

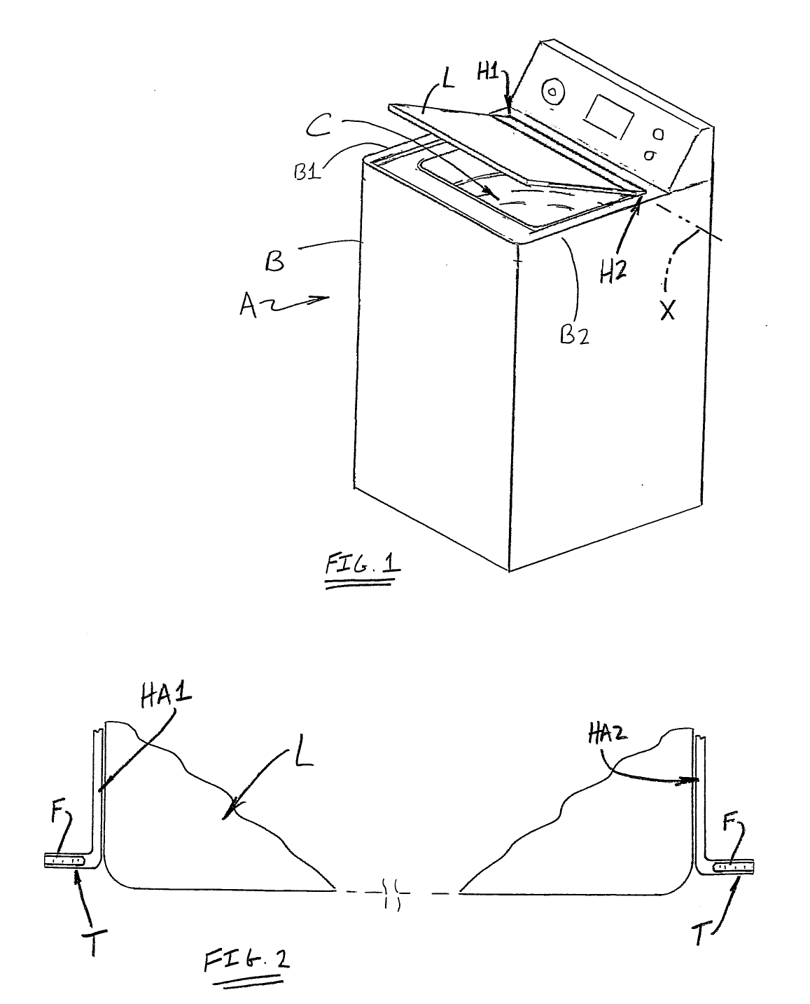

FIG. 1 shows a top-loading appliance A such as a clothes washing machine or dryer. The appliance A includes a body B and a lid L that is pivotally connected to the body B and adapted for pivoting movement relative to the body about a horizontal pivot axis X between a closed position, where the lid L covers or blocks access to a chamber C located inside the body, and an opened position, in which the lid L is moved to a position where it uncovers or opens and allows access to the chamber C. FIG. 1 shows the lid L in a partially opened position located between the closed position (also referred to as the fully closed position) and an opened position (also referred to as the fully opened position). Typically, the fully opened position of the lid is slightly greater than 90 degrees away from the closed position.

The lid L is operatively secured to the body B for such pivoting movement by a first hinge or hinge assembly H1 located adjacent a first lateral side of the lid L/body B and a second hinge or hinge assembly H2 located adjacent a second lateral side of the lid L/body B (the hinge assemblies H1,H2 are sometimes generally referred to herein as hinge assemblies H). Either one or both of the hinge assemblies H1,H2 are provided in accordance with the present development as described herein.

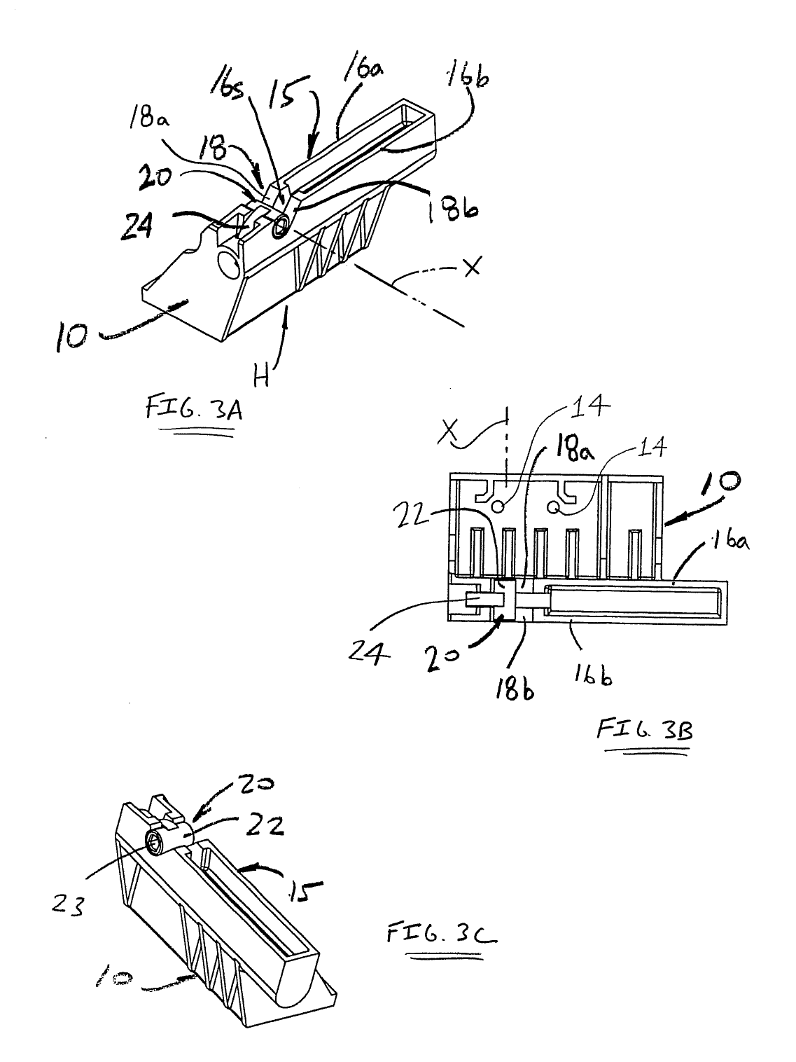

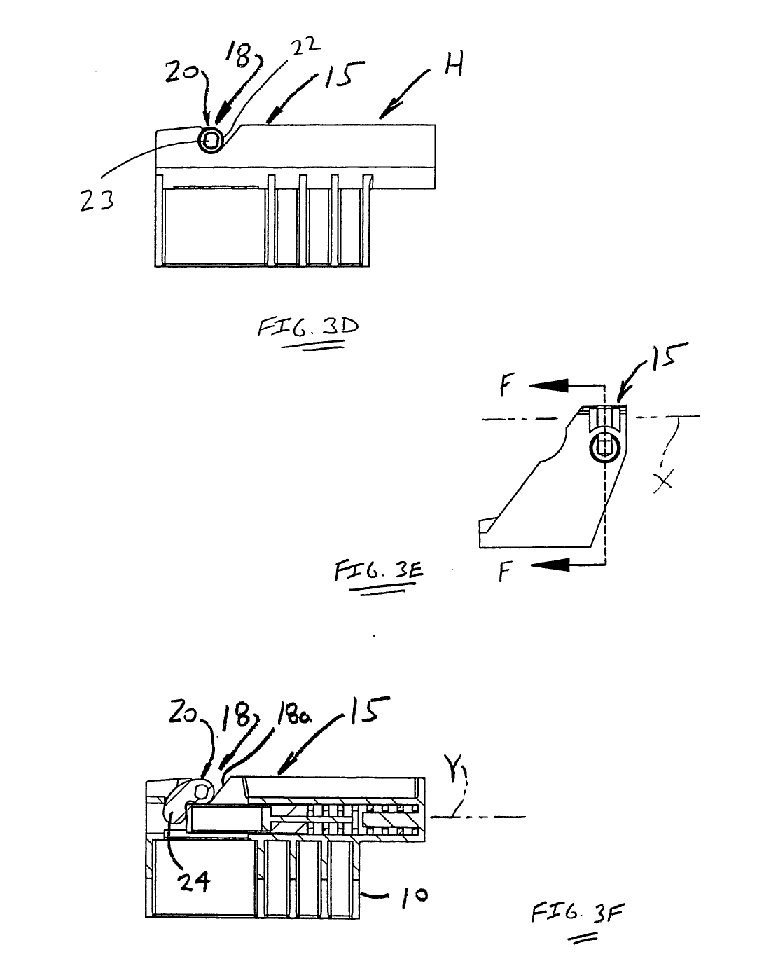

FIG. 2 shows the lid by itself, and it can be seen that first and second hinge arms HA1,HA2 are connected respectively to opposite first and second lateral sides of the lid L, respectively. Each hinge arm HA1,HA2 comprises a metal wire form or like structure secured to or otherwise provided as part of the lid L and comprising a tip T that projects transversely outward away from the lid. Each tip T includes one or more flats F or is otherwise defined with a non-circular cross-section for non-rotatable engagement with the respective mating hinge assembly H1,H2 (see also FIG. 3) connected to the appliance body B as described below for pivotally securing the lid L to the body B. The hinge arms HA1,HA2 can have other structures or be defined from other materials, e.g., the hinge arms can be provided by a metal or molded polymeric stud connected to or provided as part of the lid L and projecting outwardly therefrom. Each hinge assembly H can alternatively be referred to as a motion control assembly, in which case the hinge arms HA1,HA2 can each be referred to as a hinge that engages the motion control assembly H.

FIGS. 3A-3F (collectively referred to herein as FIG. 3) provide six different views of a hinge assembly H (H1,H2) provided in accordance with the present development. The hinge assembly H is optionally constructed to be ambidextrous in that it functions as either a first hinge assembly H1 or the second hinge assembly H2, depending upon where it is mounted to the appliance body B, i.e., the hinge assembly H is mounted adjacent a first lateral side B1 of the body B and chamber C to be engaged by the first lid hinge arm HA1 when acting as a first hinge assembly H1, and the hinge assembly H is mounted adjacent an opposite second lateral side B2 of the body B and chamber C to be engaged by the second lid hinge arm HA2 when acting as a second hinge assembly H2. Alternatively, the hinge assembly H illustrated in FIG. 3 is a first hinge assembly H1 only (or a second hinge assembly H2 only) in which case the second hinge assembly H2 (or the first hinge assembly H1) is constructed as a mirror image of the illustrated hinge assembly H.

The hinge assembly H comprises a base 10 preferably defined as a unitary or one-piece molded polymeric structure including a mounting flange 12 comprising one or more apertures 14 that receive a rivet, screw or like fastener for operatively securing the base to the appliance body B. Alternatively, the base 10 is a metal structure and/or is assembled from multiple pieces of metal and/or polymeric material.

An outer or upper portion 15 of the base 10 comprises a notch or other recess 18, and the hinge assembly H further comprises a cam 20 located in the notch 18 and adapted for rotation in first and second opposite directions, with the first direction corresponding to movement of the lid L from its opened position toward its closed position, and the second direction corresponding to movement of the lid L from its closed position toward its opened position. More particularly, the upper portion 15 of the base 10 comprises first and second parallel, spaced-apart support walls 16a,16b that define a space or slot 16s there between. The walls 16a,16b include respective notches or recesses 18a,18b that are aligned or registered with each other to provide or define the notch/recess 18 in which the cam 20 is received and rotatably supported. In an alternative embodiment, one or both of the notches or recesses 18a,18b are provided by or comprise a hole or aperture with an enclosed perimeter and in which the opposite ends of the cam are respectively supported for rotation relative to the base 10.

The cam 20 comprises a cam shaft 22 having its opposite ends respectively supported for rotation in the notches 18a,18b, and the cam 20 further comprises a cam lobe, ear, tab, or other projection 24 that extends or projects radially outwardly from the cam shaft 22 between its opposite ends. The cam lobe 24 is located in the space 16s defined between the support walls 16a,16b for at least certain angular positions of the cam 20. The cam shaft 22 rotates in the recess 18 relative to the base 10 about the axis of rotation X.

At least one or both opposite ends of the camshaft 22 are adapted to be connected to one of the lid hinge arms HA1,HA2 such that the hinge arm HA1,HA2 and the camshaft 22 rotate together about the axis of rotation X. In the illustrated embodiment, the opposite ends of the camshaft 22 include respective non-circular apertures or recesses 23 that non-rotatably receive and mate with the tip T of an associated hinge arm HA1,HA2 in a non-rotatable or keyed manner, but other mating connections between a hinge arm HA1,HA2 and the camshaft 22 can be used. When the tip T of an appliance lid hinge arm HA1,HA2 is mated with one of the cam apertures 23, the cam 20 rotates in response to pivoting movement of the lid between its opened and closed positions. In an alternative embodiment, the cam 20 is provided as part of a hinge arm HA1,HA2, for example the cam 20 is provided as a one-piece construction with or otherwise connected to the remainder of the hinge arm HA1,HA2, in which case the lid L is connected directly to the hinge assembly H when secured to the hinge arm HA1,HA2 by one or more fasteners, welding, and/or otherwise.

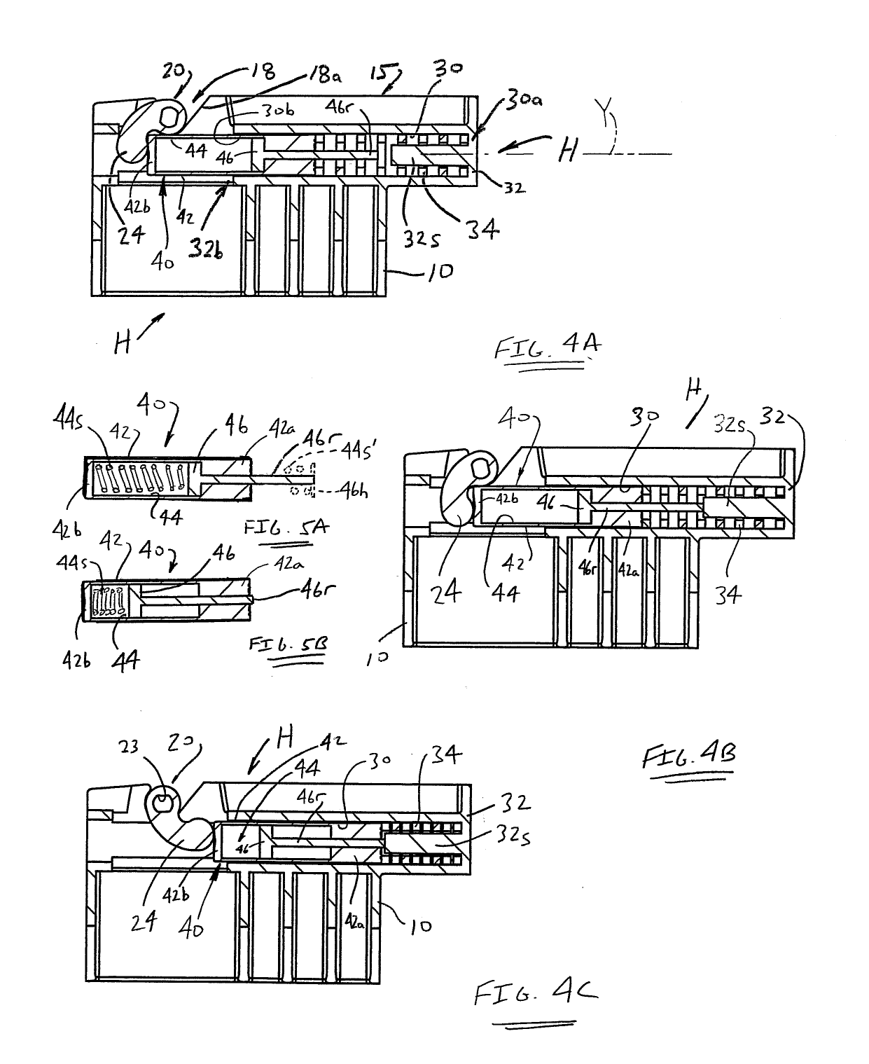

FIG. 4A is a cross-section of the hinge assembly H as taken at line F-F of FIG. 3E that shows the hinge assembly H in a first position corresponding to a fully opened position of the appliance lid L. FIG. 4C is similar to FIG. 4A but shows the hinge assembly H in a second position where the cam 20 has been rotated to a position corresponding to the appliance lid L being fully closed. FIG. 4B is similar to FIGS. 4A and 4C but shows the hinge assembly H in an intermediate position where the cam 20 has been rotated to a position corresponding to the appliance lid being partially opened or partially closed, i.e., the lid L is located partially between its fully opened and closed positions. Comparing FIGS. 4A-4C, it can be seen that rotation of the cam 20 causes the cam lobe 24 to move to and between a first position (FIG. 4A), an intermediate position (FIG. 4B), and a second position (FIG. 4C).

A hinge assembly H provided in accordance with the present development includes at least one shock-absorber, damper, or other “snubber” 40 that is connected to and operatively supported by the base 10. The snubber 40 is contacted by the cam lobe 24 for at least part of the arc on which the cam lobe 24 moves in a first rotational direction from its first position (FIG. 4A) toward its second position (FIG. 4C) during movement of the appliance lid L from an opened position to the closed position, and the snubber 40 resists movements of the cam lobe 24 in the first direction when it is contacted by the cam lobe 24 which, in turn, damps movement and prevents slamming of the lid L when it moves from an opened position to the closed position and contacts the appliance body B.

In FIG. 4A, its can be seen that the hinge assembly base 10 comprises a laterally or horizontally extending snubber installation bore 30. A first end 30a of the bore 30 is closed by a bore inner wall or bore end wall 32 or is otherwise partially or fully occluded, and the opposite second end 30b of the bore 30 is open and intersects/communicates with the slot 16s of the base in which the cam lobe 24 moves. A primary spring 34 such as a coil spring is located in the closed end 30a of the bore 30 and is abutted with the bore inner wall 32. In the illustrated embodiment, an optional locating peg or locating stud 32s projects into the bore 30 from the bore inner wall 32 and the primary spring 34 is coaxially positioned about the stud 32s such that the stud 32s extends into the hollow core of the primary spring 34 to maintain proper location and alignment of the spring 34 in the bore 30 and to provide a reaction structure or surface against with the snubber 40 acts, but the locating stud 32s can be omitted in which case the bore inner wall 32 provides the reaction surface for the snubber 40. Alternatively the base includes a larger snubber installation bore 30 or multiple parallel snubber installation bores 30, and two or more parallel snubbers 40 are located in the single or multiple installation bore(s) 30, wherein both snubbers 40 are operatively engaged by the cam 20 as described herein for the single snubber 40.

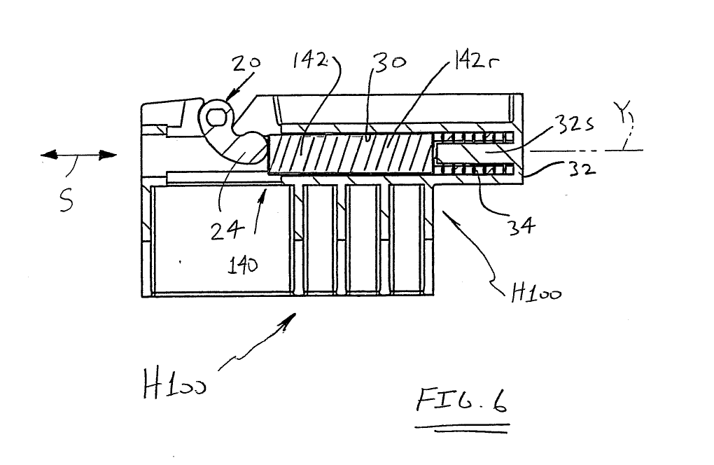

In the illustrated embodiment, the snubber 40 is located in the bore 30 and acts as a damper to counteract or attenuate closing force acting on the appliance lid L by gravity and/or as applied to the lid L by a user to prevent or at least resist slamming of the lid L against the body B when the lid moves from an opened position to its closed position. FIGS. 5A and 5B show one example of a suitable snubber 40, which is a self-contained damper cylinder that uses air, oil or another damping fluid and/or that uses a mechanical spring for damping.

As shown, the snubber 40 comprises a snubber body 42 including a bore 44 defined therein and in which the damping fluid and/or mechanical damping spring is located. A first end wall 42a is connected to or otherwise provided as part of the snubber body 42 and closes a first end 44a of the snubber bore 44. A piston 46 is slidably located in the bore 44 and a piston rod 46r is connected to and projects outwardly from the piston 46 through the end wall 42a. The piston 46 is slidable between an extended position where it is located close to the end wall 42a and the piston rod 46r extends through and outwardly away from the end wall 42a (as shown in FIG. 5A) and a retracted position where the piston 46 is moved away from the first end wall 42a toward a second end wall 42b of the snubber body 42 that is spaced from the first end wall 42a and that closes an opposite inner or second end 44b of the snubber bore 44 as compared to the first end wall 42a and where the piston rod 46r is moved or retracted at least partially into the bore 44 (as shown in FIG. 5B) such that the piston rod 46r projects outwardly from the first end wall 42a to a lesser extent as compared to the extended position or is completely retracted into the bore 44 so that it does not project outwardly from the first end wall 42a.

A piston return spring 44s (shown in FIGS. 5A & 5B but not shown in FIGS. 4A-4C), such as a coil spring, is operatively located in the bore 44 between the second end wall 42b and the piston 46 and urges or biases the piston 46 toward its extended position. In another embodiment, the piston return spring 44s is additionally or alternatively provided external relative to the snubber body 42, i.e., located outside the body 42/bore 44 as partially shown in broken lines at 44s′ and is coaxially position about the piston rod 46r and operatively engaged between the body 42 and an enlarged head 46h or other part of the tip or outer end of the piston rod 46r. The oil, air, or other damping fluid is located in the snubber bore 44. Snubber activation force such as inwardly directed axial force exerted on an outermost end of the piston rod 46r in a direction toward the second end wall 42b and/or an opposite force exerted on the snubber body 42 causes the piston 46 to move toward its retracted position, and the action of the damping fluid on the piston 46 resists or damps such inward movement of the piston 46, i.e., the piston 46 includes an orifice or other restricted flow path for the damping fluid to pass through or around the piston to provide resistance to inward movement of the piston. When the snubber activation force or forces acting on the snubber 40 are removed, the piston return spring 44s urges the piston 46 back to its extended position. Preferably, the piston 46 is configured such that the damping fluid passes through and/or around the piston with less resistance when the piston is moving outward from its retracted position toward its extended position, as compared to when the piston 46 is moving inward from its extended position toward its retracted position. Accordingly, the snubber 40 provides greater damping force during movement of the piston from its extended position toward its retracted position as compared to movement of the piston 46 in the opposite direction, which ensures that the piston 46 will move more quickly and easily from its retracted position to its extended position under force of the return spring 44s to reduce the time required for the snubber to reset (the time required for the piston 46 to become fully extended again from its retracted position) after removal of the snubber activation force(s).

In the illustrated embodiment, the snubber 40 is operatively connected to the base 10 by insertion of the snubber body 42 into the snubber installation bore 30 of the base 10. As shown, the snubber body 42 is reciprocally linearly movable relative to the base 10 in the snubber installation bore 30 on a snubber axis Y that is oriented perpendicularly but offset from the lid pivot axis X to and between a first (extended) position (FIG. 4A) and a second (retracted) position (FIG. 4C) through in intermediate position (FIG. 4B). In its second position, the snubber body 42 is moved into the snubber installation bore 30 toward the bore inner wall 32, and in its first position, the snubber body 42 is moved outwardly away from the bore inner wall 32 toward the cam lobe 24. As shown herein, the snubber 40 is oriented with its rod 46r directed or pointing into the snubber installation bore 30 toward the bore inner wall 32 and coaxially aligned with the locating stud 32s. In this arrangement, the piston rod 46r extends coaxially into the central core of the primary spring 34 and abuts the locating stud 32s, at least when the snubber 40 is urged into the bore 30 and activated as described below. In an alternative embodiment, the locating stud is omitted and the piston rod 46r abuts the bore inner wall 32, at least when the snubber 40 is urged into the bore 30 and activated as described below. In either case, the primary spring 34 engages the snubber body 42 and urges the snubber body 42 outwardly away from the bore inner wall 32. In the illustrated embodiment, the primary spring 34 biases the snubber body 42 into continuous abutment or engagement with the cam lobe 24 for all rotational positions of the cam 20 as can be seen in FIGS. 4A-4C to limit impact forces being exerted on the snubber body 42 by the cam lobe 24 as would occur if the cam lobe separated from the snubber body when the appliance lid is opened. Contact between the cam lobe 24 and the snubber body 42 also results in the primary spring 34 providing some continuous counterbalance force on the cam 20 that urges the cam 20 (and lid L engaged therewith) in the second (lid-opening) rotational direction to provide some assistance to manual opening of the lid L by a user and to provide some additional damping force during closing of the lid L as the cam rotates in the first direction against the biasing force of the primary spring 34.

In use, as shown in FIGS. 4A-4C, as the cam 20 rotates during movement of the lid L in the first or lid-closing direction from an opened position toward the closed position for the lid L, the cam lobe 24, which is preferably already directly in contact with the second end wall 42b of the snubber body 42 due to the biasing force of the primary spring 34, urges the snubber body 42 inward toward the bore inner wall 32 such that the piston rod 46r contacts the locating stud 32s if the piston rod is not long enough to already be in contact with the stud 32 and such that a snubber activation force is applied to the snubber 40 and the snubber thus exerts an opposite reaction damping force against the rotation of the cam 20 and cam lobe 24 to slow rotation of the cam 20. In particular, the cam lobe 24 urges the snubber body 42 inward from the position shown in FIG. 4A toward the bore inner wall 32 against the biasing force of the primary spring 34 such that the piston rod 46r contacts the locating stud 32s (or the bore inner wall 32 if the stud 32s is omitted) as shown in FIG. 4B. Continued movement of the lid L in the closing direction causes the cam lobe 24 to move the snubber body 42 further inward toward the bore inner wall 32 against the biasing force of the primary spring 34, but the piston rod 46r is blocked by the locating stud 32s from further movement toward the bore inner wall 32. Continued inward movement of the snubber body 42 by the cam lobe 24 thus causes the piston 46 to move through the damping fluid located in the snubber bore 44 from its extended position (FIG. 4B) to its retracted position (FIG. 4C) such that the snubber 40 resists and damps movement of lid L in the closing direction until the lid L is moved completely to its closed position as shown in FIG. 4C (the compression of the primary spring 34 as described above also provides some damping resistance force). Advantageously, the snubber 40 and/or primary spring 34 do not exert sufficient force on the cam lobe 24 to rotate the cam 20 in the second (lid-opening) direction spontaneously as would result in the appliance lid partially opening with undesired effect as described above. In an alternative embodiment, the cam lobe 24 separates from the snubber body 42 when the cam is rotated fully in the second (lid-opening) direction.

Upon movement of the lid L in an opposite direction from its closed position toward its opened position, the cam 20 will rotate in the opposite direction such that the cam lobe 24 moves away from the bore inner wall 32 which results in the primary spring 34 moving the snubber body 42 away from the bore inner wall 32 and which results in removal of the snubber activation force which allows the piston return spring 44s to move the piston from its retracted position (FIG. 4C) to its extended position (FIG. 4A). In an alternative embodiment, the primary spring 34 is omitted in which case the piston return spring 44s acts to move the snubber body 42 away from the bore inner wall 32 to reset the snubber upon removal of the snubber activation force.

In an alternative embodiment, the orientation of the snubber 40 in the installation bore 30 is reversed such that the piston rod 46r projects out of the open end 30b of the snubber installation bore 30 and is engaged by the cam lobe 24 when the lid L is moved in the closing direction from an opened position to the closed position. In such case, the second end wall 42b of the snubber body will compress the primary spring 34 and move into abutment with the locating stud 32s (or into abutment with the bore inner wall 32 if the locating stud 32s is omitted) during the initial stages of closing movement of the lid L, and further closing movement of the lid L will then cause the cam lobe 24 to push the piston rod 46r inwardly toward the second end wall 42b of the snubber body 42 so that the piston 46 is urged from its extended position toward its retracted position to provide the required damping. As noted above, the primary spring 34 is optionally omitted in this embodiment in which case the snubber body 42 abuts the bore inner wall 32.

In still another alternative embodiment as shown in FIG. 6, the snubber 140 includes a snubber body 142 comprising a snubber rod 142r located in the snubber bore 30 and engaged with the primary spring 34 to provide a rod-snubber hinge assembly H100. The snubber rod 142r is movable relative to the base 10 in the snubber bore 30 along the snubber axis Y in a linear reciprocal manner as indicated by the arrow S between a first (extended) position and a second (retracted) position. In its second position as shown in FIG. 6, the snubber rod 142r is moved into the snubber installation bore 30 toward the bore inner wall 32, and in its first position, the snubber rod 142r is moved outwardly away from the bore inner wall 32 toward the cam lobe 24. In such case, the cam lobe 24 engages the snubber rod 142r and exerts a snubber activation force on the snubber rod 142r when the cam rotates in the first direction in response to movement of the lid L in the closing direction from an opened position toward the closed position (the closed position is shown in FIG. 6) and moves the snubber rod 142r inwardly from its first positon toward the bore inner wall 32 to its second position against the biasing force of the primary spring 34 such that the primary spring 34 resists and damps movement of the lid L in the closing direction. The primary spring 34 also provides some counterbalance force to urge the snubber rod 142r outwardly toward its first position away from the bore inner wall 32 and urges the cam lobe 24 in its second rotational direction to assist in movement of the lid L in the opening direction toward the opened position.

The appliance A can use only one snubber hinge assembly H, as either the first or second hinge assembly H1,H2, in which case the other hinge H1,H2 assembly is provided by any other suitable hinge structure or assembly. Alternatively, both the first and second hinge assemblies H1,H2 are provided by a snubber hinge assembly H constructed in accordance with the present development as shown in FIG. 3 and/or as a mirror image as described above. In still another alternative embodiment, one of the hinge assemblies H1,H2 is provided by a snubber hinge assembly H as shown in FIG. 3 while the other hinge assembly H1,H2 is provided by a rod-snubber hinge assembly H100 as shown in FIG. 6.

The present development has been described with reference to preferred embodiments. Modifications and alterations will occur to those of ordinary skill in the art to which the present development pertains, and it is intended that the claims be construed as broadly as possible to encompass all such modifications and alterations while preserving the validity of the claims.

1. A hinge assembly for pivotally connecting an associated appliance lid to an associated appliance body, said hinge assembly comprising:
a base adapted to be connected to the associated appliance body;
a cam rotatably supported on said base, said cam adapted to be engaged by the associated appliance lid and rotatable about a lid pivot axis;
a snubber operatively connected to the base, wherein said cam exerts a snubber activation force on said snubber when said cam rotates about said lid pivot axis in a first direction corresponding to movement of the associated appliance lid from an opened position toward a closed position and such that said snubber damps movement of said cam when said cam rotates in said first direction.

2. The hinge assembly as set forth in claim 1, wherein said snubber comprises:
a snubber body including a bore defined therein;
a piston slidably located in the bore and a piston rod connected to and projecting outwardly from the piston through a first end wall of the snubber body;
said piston slidable to and between an extended position and a retracted position, wherein said piston is located closer to said first end wall of said snubber body and said piston rod projects outwardly away from the first end wall of the snubber body to a greater extent when said piston is located in said extended position as compared to when said piston is located in said retracted position.

3. The hinge assembly as set forth in claim 2, wherein said snubber body further comprises a second end wall that is spaced from the first end wall, and said snubber further comprises a piston return spring that urges the piston toward its extended position.

4. The hinge assembly as set forth in claim 3, further comprising a damping fluid located in the snubber bore such that:
said snubber activation force causes the piston to move from its extended position toward its retracted position, and the damping fluid resists inward movement of the piston toward said bottom wall;
when the snubber activation force is removed from said snubber, the piston return spring urges the piston toward its extended position to reset the snubber.

5. The hinge assembly as set forth in claim 4, wherein the piston is configured such that the damping fluid passes by the piston with less resistance when the piston is moving from its retracted position toward its extended position as compared to when the piston is moving from its extended position toward its retracted position such that said snubber provides greater damping force during movement of the piston from its extended position toward its retracted position as compared to movement of the piston from its retracted position toward its extended position.

6. The hinge assembly as set forth in claim 2, further comprising a primary spring operatively positioned between said base and said snubber body and biasing said snubber body toward a first position, said snubber body selectively moveable by said snubber activation force into said bore toward a second position.

7. The hinge assembly as set forth in claim 6, wherein said base comprises a one-piece polymeric construction.

8. The hinge assembly as set forth in claim 1, wherein said snubber comprises:
a snubber rod movably connected to said base and adapted for reciprocal linear sliding movement between a first position and a second position;
a primary spring located between said base and said snubber rod and biasing said snubber rod toward its first position;
wherein said snubber rod moves from said first position toward said second position against said biasing force of said primary spring in response to said snubber activation force exerted thereon by said cam when said cam rotates about said lid pivot axis in said first direction corresponding to movement of the associated appliance lid from the opened position toward the closed position primary spring damps movement of said cam when said cam rotates in said first direction.

9. The hinge assembly as set forth in claim 4, wherein said piston return spring is operatively located in the bore between the second end wall and the piston.

10. The hinge assembly as set forth in claim 4, wherein said piston return spring is located external relative to said snubber body and is operatively located between the snubber body and an outer end of said piston rod.

11. The hinge assembly as set forth in claim 6, wherein said primary spring biases said snubber body into continuous abutment with the cam for all operative positions of said cam.

12. An appliance comprising:
a body including a chamber with an open mouth;
a lid for selectively covering the open mouth of the chamber; and
hinge assembly for pivotally connecting the lid to the body, said hinge assembly comprising:
a base connected to the body;
a cam rotatably supported on said base, said cam engaged the lid and rotatable with the lid about a lid pivot axis;
a snubber operatively connected to the base, wherein said cam exerts a snubber activation force on said snubber when said cam rotates about said lid pivot axis in a first direction corresponding to movement of the lid from an opened position toward a closed position and such that said snubber damps movement of said cam when said cam rotates in said first direction with said lid.
